(19) United States
(12) Patent Application Publication
(10) Pub. No.: US 2024/0066730 A1
(43) Pub. Date: Feb. 29, 2024

(54) ADJUSTABLE-TAPER COMB ATTACHMENT FOR A HAIR CLIPPER

(71) Applicant: Abdulaziz Esmaeel Al-Ansari, Doha (QA)

(72) Inventor: Abdulaziz Esmaeel Al-Ansari, Doha (QA)

(21) Appl. No.: 17/894,615

(22) Filed: Aug. 24, 2022

(51) Int. Cl. B26B 19/20; B26B 19/38

(52) U.S. Cl. CPC B26B 19/20; B26B 19/3813

(57) ABSTRACT

A comb attachment for use with a hair clipper is provided. The comb attachment comprises a comb blade guide having a plurality of fins, a base case configured to be removably attached to a hair clipper, a first guiding slider, and a second guiding slider. Each of the plurality of fins comprises a first end portion, a middle portion, and a second end portion opposite the first end portion. The base case comprises a first wall, a second wall, a third wall opposite the first wall, and a fourth wall opposite the second wall. The first, second, third, and fourth walls together form an internal hollow space configured to accept the hair clipper. The first and second guiding sliders are configured to adjust a taper angle of the comb blade guide and a length of the comb attachment.

### BACKGROUND

A comb attachment may be used with a hair clipper. The comb attachment may help the user of the hair clipper to trim the hair of the subject in a uniform length. For example, the comb attachment may help the user of the hair clipper to keep a predetermined distance between the blade of the hair clipper and the scalp of the subject.

There could be various types of comb attachments. Conventional hair-clipper comb attachments are normally in a rigid form. Fixed/rigid comb attachments may also have a predefined taper or slope that allows a hair clipper to cut hair at a uniformly increasing length. However, such attachments are available in a rigid form, where the direction of the taper and the length are fixed. In some conventional comb attachments, the length may be adjustable, but they allow only to increase or decrease the length to several predetermined length values with no other freedom in motion.

### SUMMARY

The present disclosure provides an adjustable-taper comb attachment for a hair clipper. In an example, the comb attachment may include a comb blade guide having a plurality of fins. Each of the plurality of fins may include a first end portion; a middle portion, where the middle portion may be bent; and a second end portion opposite the first end portion. The comb attachment may further include a base case configured to be removably attached to a hair clipper, a first guiding slider, and a second guiding slider. The base case may include a first wall, a second wall, a third wall opposite the first wall, and a fourth wall opposite the second wall. The first, second, third, and fourth walls together may form an internal hollow space configured to accept the hair clipper. The first end portion of each of the plurality of fins may be movably attached to an outer surface of the first wall, and the second end portion of each of the plurality of fins may be movably attached to an outer surface of the third wall. The first guiding slider may be movably attached to an outer surface of the second wall, and the second guiding slider may be movably attached to an outer surface of the fourth wall. The first and second guiding sliders may be configured to adjust a taper angle of the comb blade guide and a length of the comb attachment.

In some examples of the present disclosure, which may be used in combination with any other example or combination of examples listed herein, the first wall of the base case may include a first group of sliding recesses formed on the outer surface thereof. Each of the first group of sliding recesses may be configured to accept the first end portion of a corresponding fin. The first end portion of the corresponding fin may be configured to slide back and forth on a corresponding sliding recess on the first wall.

In some examples of the present disclosure, which may be used in combination with any other example or combination of examples listed herein, the third wall of the base case may include a second group of sliding recesses formed on the outer surface thereof. Each of the second group of sliding recesses may be configured to accept the second end portion of a corresponding fin. The second end portion of the corresponding fin may be configured to slide back and forth on a corresponding sliding recess on the third wall.

In some examples of the present disclosure, which may be used in combination with any other example or combination of examples listed herein, the comb attachment may further include a first connector coupled to the first guiding slider and the second guiding slider. The first end portion of each of the plurality of fins may include a recess configured to accept the first connector.

In some examples of the present disclosure, which may be used in combination with any other example or combination of examples listed herein, the comb attachment may further include a second connector coupled to the first guiding slider and the second guiding slider, wherein the second end portion of each of the plurality of fins includes a recess configured to accept the second connector.

In some examples of the present disclosure, which may be used in combination with any other example or combination of examples listed herein, the second wall of the base case may include a first protrusion, and the first guiding slider may include a first groove configured to accept the first protrusion. The first guiding slider may be configured to slide back and forth along the first protrusion.

In some examples of the present disclosure, which may be used in combination with any other example or combination of examples listed herein, the first protrusion may include one or more side surfaces facing the first guiding slider. The one or more side surfaces of the first protrusion may include a plurality of first sections defined by a plurality of first sub-protrusions. The first guiding slider may be secured within one of the plurality of first sections.

In some examples of the present disclosure, which may be used in combination with any other example or combination of examples listed herein, the fourth wall of the base case may include a second protrusion, and the second guiding slider may include a second groove configured to accept the second protrusion. The second guiding slider may be configured to slide back and forth along the second protrusion.

In some examples of the present disclosure, which may be used in combination with any other example or combination of examples listed herein, the second protrusion may include one or more side surfaces facing the second guiding slider. The one or more side surfaces of the second protrusion may include a plurality of second sections defined by a plurality of second sub-protrusions. The second guiding slider may be secured within one of the plurality of second sections.

In some examples of the present disclosure, which may be used in combination with any other example or combination of examples listed herein, the first end portion and the second end portion of the fins may be substantially in parallel with each other.

In some examples of the present disclosure, which may be used in combination with any other example or combination of examples listed herein, the taper angle of the comb blade guide may be adjusted by a relative movement of the first guiding slider and the second guiding slider.

In some examples of the present disclosure, which may be used in combination with any other example or combination of examples listed herein, the length of the comb attachment may be increased by pushing the comb blade guide in a distal direction using the first guiding slider and the second guiding slider.

In some examples of the present disclosure, which may be used in combination with any other example or combination of examples listed herein, the length of the comb attachment may be decreased by pulling the comb blade guide in a proximal direction using the first guiding slider and the second guiding slider.

In some examples of the present disclosure, which may be used in combination with any other example or combination of examples listed herein, the taper angle may be in a range of about −30° to +30°.

In some examples, a hair-clipping assembly is provided. The hair-clipping assembly may include a hair clipper and a comb attachment. The comb attachment may include a comb blade guide having a plurality of fins. Each of the plurality of fins may include a first end portion; a middle portion, where the middle portion may be bent; and a second end portion opposite the first end portion. The comb attachment may further include a base case configured to be removably attached to the hair clipper, a first guiding slider, and a second guiding slider. The base case may include a first wall, a second wall, a third wall opposite the first wall, and a fourth wall opposite the second wall. The first, second, third, and fourth walls together may form an internal hollow space configured to accept the hair clipper. The first end portion of each of the plurality of fins may be movably attached to an outer surface of the first wall, and the second end portion of each of the plurality of fins may be movably attached to an outer surface of the third wall. The first guiding slider may be movably attached to an outer surface of the second wall, and the second guiding slider may be movably attached to an outer surface of the fourth wall. The first and second guiding sliders may be configured to adjust a taper angle of the comb blade guide and a length of the comb attachment.

The advantages discussed herein may be found in one, or some, and perhaps not all of the embodiments disclosed herein. Additional features and advantages are described herein, and will be apparent from the following Detailed Description and the figures.

### BRIEF DESCRIPTION OF THE DRAWINGS

FIG. 1 is a perspective, exploded view of a schematic diagram of an example comb attachment according to an example of the present disclosure.

FIG. 2 is a front view of a schematic diagram of the example comb attachment of FIG. 1.

FIG. 3 is a side view of a schematic diagram of the example comb attachment of FIG. 1.

FIG. 4 is an enlarged perspective view of a schematic diagram of the example comb attachment of FIG. 1.

FIG. 5 is a perspective view of a schematic diagram of an example fin of the comb attachment of FIG. 1.

FIG. 6 is a perspective view of a schematic diagram of an example base case of the comb attachment of FIG. 1.

FIG. 7 is a perspective view of a schematic diagram of example first and second guiding sliders of the comb attachment of FIG. 1.

FIG. 8 is a front view of a schematic diagram of the example comb attachment of FIG. 1 in a different taper angle.

FIG. 9 is a front view of a schematic diagram of the example comb attachment of FIG. 1 in a different taper angle.

FIG. 10 is a schematic diagram of an example range of taper angles of the example comb attachment of FIG. 1.

### DETAILED DESCRIPTION

Conventional hair-clipper comb attachments are normally in a rigid form. Fixed/rigid comb attachments may have a predefined taper or slope that allows a hair clipper to cut hair at a uniformly increasing length. However, such attachments are available in a rigid form, where the direction of the taper and the length are fixed. In some conventional comb attachments, the length may be adjustable, but they allow only to increase or decrease the length to several predetermined length values with no other freedom in motion.

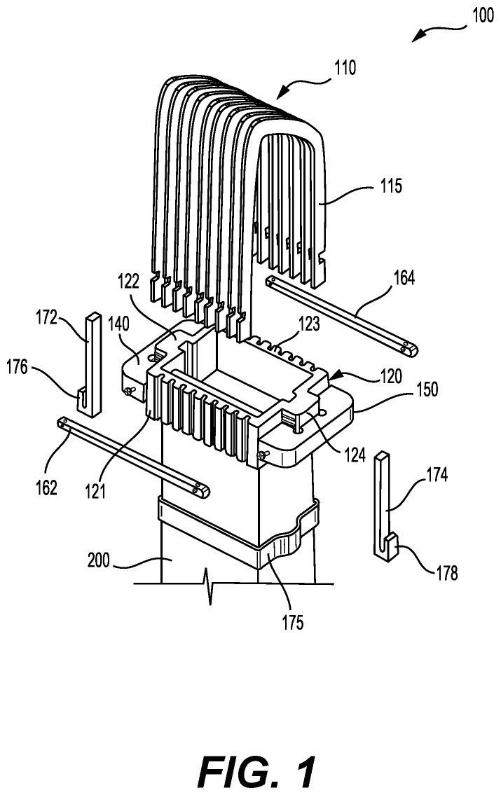

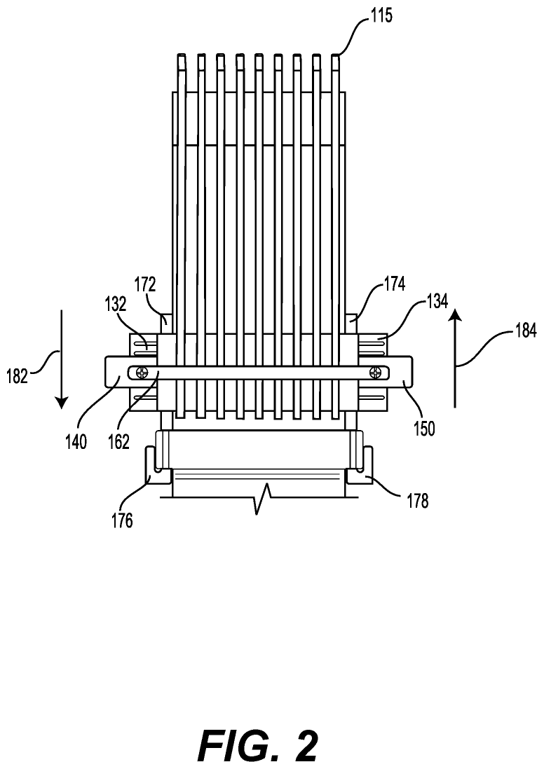

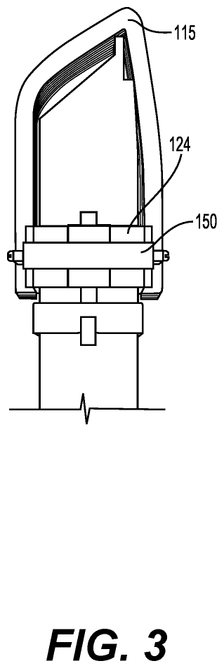

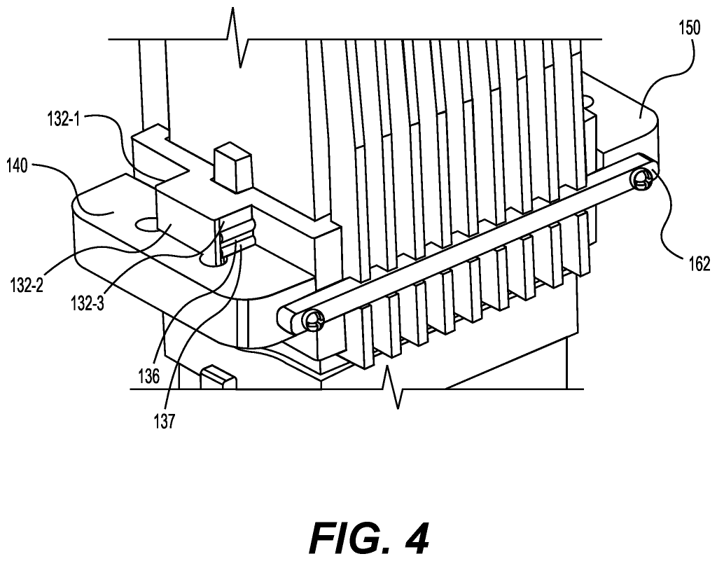

Aspects of the present disclosure may provide a comb attachment that is capable of adjusting the taper direction, taper angle, and the length simultaneously. Referring to FIGS. 1 to 4, in some examples, a comb attachment 100 for a hair clipper 200 may be provided. The comb attachment 100 may include a comb blade guide 110, a base case 120 configured to be removably attached to a hair clipper 200, a first guiding slider 140, and a second guiding slider 150.

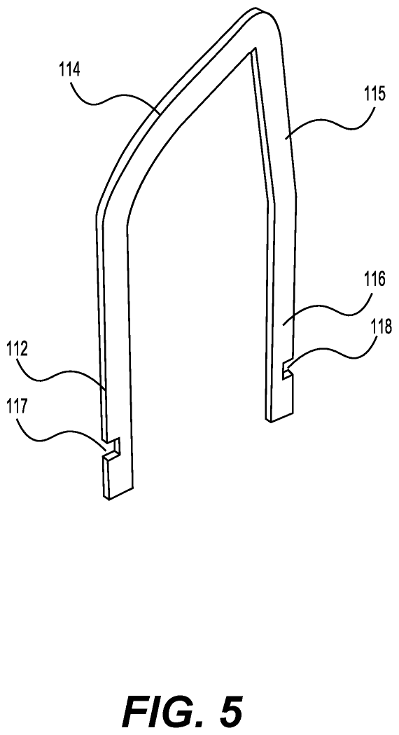

The comb blade guide 110 may include a plurality of fins 115. The plurality of fins 115 may be spaced apart from and/or in parallel with each other. As shown in FIG. 5, each of the plurality of fins 115 may include a first end portion 112, a middle portion 114, and a second end portion 116 opposite the first end portion 112. The middle portion 114 of the fins 115 may be bent. In some examples, the first end portion 112 and the second end portion 116 of the fins 115 may be substantially in parallel with each other. The fins 115 may help keep a certain distance between the scalp of the subject and the blade of the hair clipper and guide the hair to the blade. In some examples, the fins 115 may be maintained in a vertical position (e.g., parallel to the blade of the hair clipper) all the time.

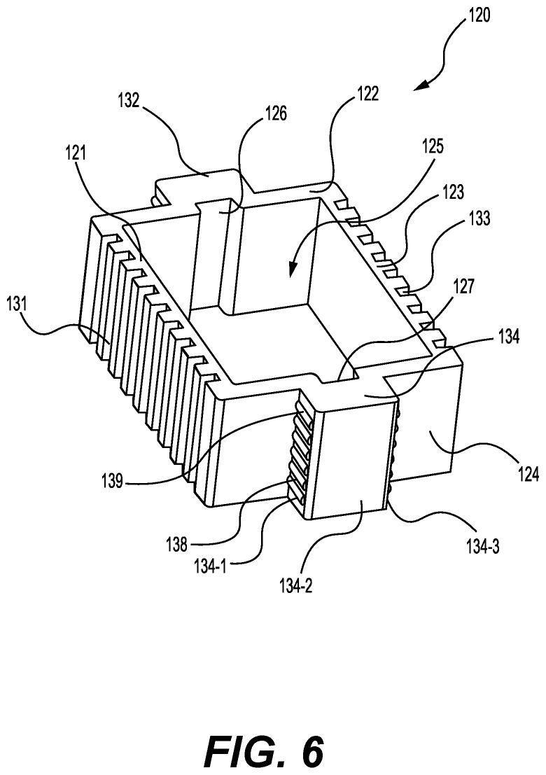

The base case 120 may be removably attached to a hair clipper 200. In some examples, as shown in FIG. 6, the base case 120 may include a first wall 121, a second wall 122, a third wall 123 opposite the first wall 121, and a fourth wall 124 opposite the second wall 122. The first, second, third, and fourth walls 121-124 together may form an internal hollow space 125 configured to accept the hair clipper 200.

In some examples, the first end portion 112 of each of the plurality of fins 115 may be movably attached to an outer surface of the first wall 121. The second end portion 116 of each of the plurality of fins 115 may be movably attached to an outer surface of the third wall 123. The first guiding slider 140 may be movably attached to an outer surface of the second wall 122. The second guiding slider 150 may be movably attached to an outer surface of the fourth wall 124. In some examples, the first guiding slider 140 may be disposed in the left portion of the base case 120, and the second guiding slider 150 may be disposed in the right portion of the base case 120.

In some examples, the first wall 121 of the base case 120 may include a first group of sliding recesses 131 formed on the outer surface thereof. Each of the first group of sliding recesses 131 may be configured to accept the first end portion 112 of a corresponding fin 115. The first end portion 112 of the corresponding fin 115 may be configured to slide back and forth on a corresponding sliding recess 131 on the first wall 121.

In some examples, the third wall 123 of the base case 120 may include a second group of sliding recesses 133 formed on the outer surface thereof. Each of the second group of sliding recesses 133 may be configured to accept the second end portion 116 of a corresponding fin 115. The second end portion 116 of the corresponding fin 115 may be configured to slide back and forth on a corresponding sliding recess 133 on the third wall 123.

When the comb attachment 100 is attached to a hair clipper 200, a blade of the hair clipper 200 may be disposed in a space within the comb blade guide 110. In some examples, the components of the comb attachment 100 may be made with a plastic material. In other examples, the components of the comb attachment 100 may be made with any other suitable material (e.g., steel, wood).

In some examples, the comb attachment 100 may further include a first connector 162 coupled to the first guiding slider 140 and the second guiding slider 150. The first connector 162 may be attached to a side surface of the first guiding slider 140 and the second guiding slider 150 near the first wall 121, for example, via a fastener. Examples of the fastener may include a stud, a bolt, or any other suitable fastener. The first connector 162 may extend from the first guiding slider 140 to the second guiding slider 150. In some examples, the first end portion 112 of each of the plurality of fins 115 may include a recess 117 configured to accept the first connector 162. The first end portion 112 of the fins 115 may be disposed between the first wall 121 and the first connector 162.

In some examples, the comb attachment 100 may further include a second connector 164 coupled to the first guiding slider 140 and the second guiding slider 150. The second connector 164 may be attached to another side surface of the first guiding slider 140 and the second guiding slider 150 near the third wall 123, for example, via a fastener. Examples of the fastener may include a stud, a bolt, or any other suitable fastener. The second connector 164 may extend from the first guiding slider 140 to the second guiding slider 150. The second end portion 116 of each of the plurality of fins 115 may include a recess 118 configured to accept the second connector 164. The second end portion 116 of the fins 115 may be disposed between the third wall 123 and the second connector 164.

The first and second connectors 162, 164 may convert the relative movement of the first and second guiding sliders 140, 150 into a rotation motion of the comb blade guide 110 so that the taper angle/direction of the comb blade guide 110 is adjusted. In some examples, the first and second connectors 162, 164 may be in a longitudinal bar shape. In other examples, the first and second connectors 162, 164 may be in any other suitable shape (e.g., plate shape, trapezoid shape). In some examples, the fins 115 of the comb blade guide 110 may be independent from each other and linked together through the first and second connectors 162, 164.

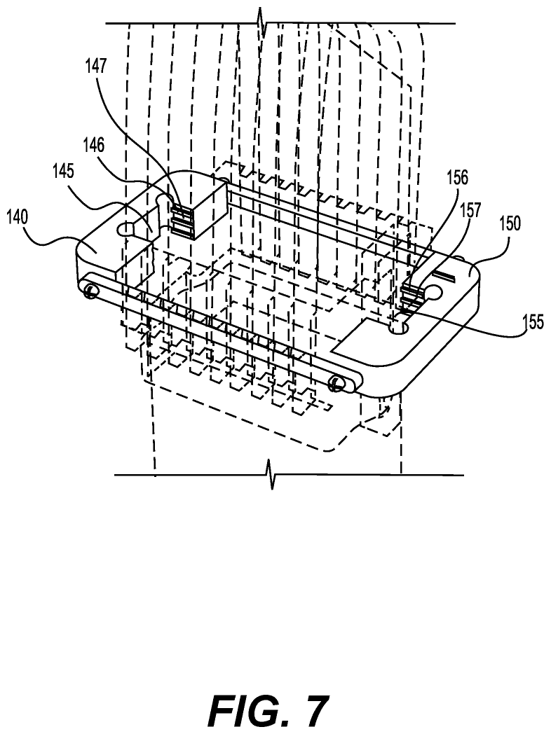

In some examples, the second wall 122 of the base case 120 may include a first protrusion 132. In some examples, as shown in FIG. 7, the first guiding slider 140 may include a first groove 145 configured to accept the first protrusion 132. The first guiding slider 140 may be configured to slide back and forth along the first protrusion 132. In some examples, the fourth wall 124 of the base case 120 may include a second protrusion 134. In some examples, as shown in FIG. 7, the second guiding slider 150 may include a second groove 155 configured to accept the second protrusion 134. The second guiding slider 150 may be configured to slide back and forth along the second protrusion 134.

In some examples, the first protrusion 132 may include one or more side surfaces facing the first guiding slider 140. For example, the first protrusion 132 may include a first side surface 132-1, a second side surface 132-2, and a third side surface 132-3. The one or more side surfaces of the first protrusion 132 may include a plurality of first sections 136 defined by a plurality of first sub-protrusions 137. The first guiding slider 140 may be secured within one or more of the plurality of first sections 136. As the first guiding slider 140 is pushed/pulled, the first guiding slider 140 may be moved up/down along the first sections 136.

In some examples, the first side surface 132-1 and the third side surface 132-3 of the first protrusion 132 may include the first sections 136 defined by the first sub-protrusions 137. In other examples, the first sections 136 and the first sub-protrusions 137 can be formed on any one or more of the first, second, and third side surfaces of the first protrusion (e.g., all of these side surfaces, only the second side surface 132-2).

In some examples, the first guiding slider 140 may also include sub-protrusions 146 and sections 147 that are configured to match the first sections 136 and first sub-protrusions 137 of the first protrusion 132, respectively. For example, the internal surfaces of the first guiding slider 140 facing the first, second, and/or third side surfaces of the first protrusion 132 (having the first sections 136 and the first sub-protrusions 137) may include the corresponding sub-protrusions 146 and sections 147.

In some examples, the second protrusion 134 may include one or more side surfaces facing the second guiding slider 150. For example, the second protrusion 134 may include a first side surface 134-1, a second side surface 134-2, and a third side surface 134-3. The one or more side surfaces of the second protrusion 134 may include a plurality of second sections 138 defined by a plurality of second sub-protrusions 139. The second guiding slider 150 may be secured within one or more of the plurality of second sections 138. As the second guiding slider 150 is pushed/pulled, the second guiding slider 150 may be moved up/down along the second sections 138.

In some examples, the first side surface 134-1 and the third side surface 134-3 of the second protrusion 134 may include the second sections 138 defined by the second sub-protrusions 139. In other examples, the second sections 138 and the second sub-protrusions 139 can be formed on any one or more of the first, second, and third side surfaces of the second protrusion 134 (e.g., all of these side surfaces, only the second side surface 134-2).

In some examples, the second guiding slider 150 may also include sub-protrusions 156 and sections 157 that are configured to match the second sections 138 and second sub-protrusions 139 of the second protrusion 134, respectively. For example, the internal surfaces of the second guiding slider 150 facing the first, second, and/or third side surfaces of the second protrusion 134 (having the second sections 138 and the second sub-protrusions 139), may include the second sub-protrusions 156 and sections 157.

The length of the comb attachment 100 can be adjusted, for example, by the first and second guiding sliders 140, 150. In some examples, the length of the comb attachment 100 may be increased by pushing the comb blade guide 110 in a distal direction 184, for example, using the first guiding slider 140 and the second guiding slider 150. The length of the comb attachment 100 may be decreased by pulling the comb blade guide 110 in a proximal direction 182, for example, using the first guiding slider 140 and the second guiding slider 150. The guiding sliders 140, 150 may have a sufficient stiffness so that they may maintain their positions once they are set at a desired position (e.g., length, taper direction, and/or taper angle).

When the guiding sliders 140, 150 are pulled all the way back in a proximal direction 182 (i.e., proximal to the user of the hair clipper 200), the comb attachment 100 may have a first (minimum) length T1. The first length may be greater than the length of the blade section of the hair clipper 200. In this case, the comb blade guide may still cover the blade section of the hair clipper 200 so that the blade section, which trims the hair of a subject, stays within the comb attachment 100. The comb blade guide 110 may cover the entire width of the blade section of the hair clipper 200 all the time, for example, regardless of the taper angle/slope.

When the guiding sliders 140, 150 are pushed all the way forward in a distal direction 184 (i.e., distal from the user of the hair clipper 200), the comb attachment 100 may have a second (maximum) length T2, which is greater than the first (minimum) length T1. By pushing and/or pulling the guiding sliders 140, 150, the length of the comb attachment 100 can be adjusted to have any length between T1 and T2. In some examples, the first (minimum) length T1 may be in a range of about 4 cm to about 8 cm. In some examples, the second (maximum) length T2 may be in a range of about 6.5 cm to about 10.5 cm.

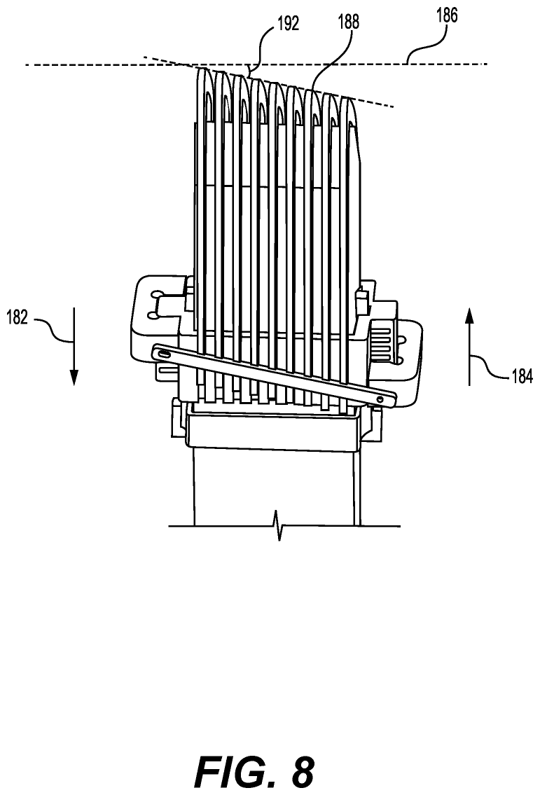

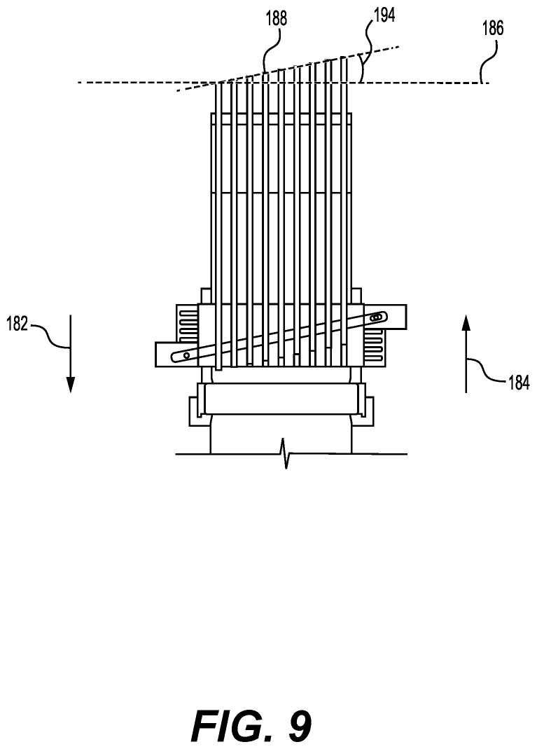

In some examples, as shown in FIGS. 8 and 9, the taper direction and taper angle of the comb attachment 100 can be adjusted, for example, by a relative movement of the guiding sliders 140, 150. For example, as shown in FIG. 8, when the first guiding slider 140 is pushed in the distal direction 184 and the second guiding slider 150 is pulled in the proximal direction 182, the comb attachment 100 may have a first taper direction (e.g., right side portion is shorter than the left side portion). In this case, the taper angle of the comb attachment 100 may have a first value 192.

As shown in FIG. 9, when the first guiding slider 140 is pulled in the proximal direction 182 and the second guiding slider 150 is pushed in the distal direction 184, the comb attachment 100 may have a second taper direction (e.g., right side portion is longer than the left side portion). In this case, the taper angle of the comb attachment 100 may have a second value 194.

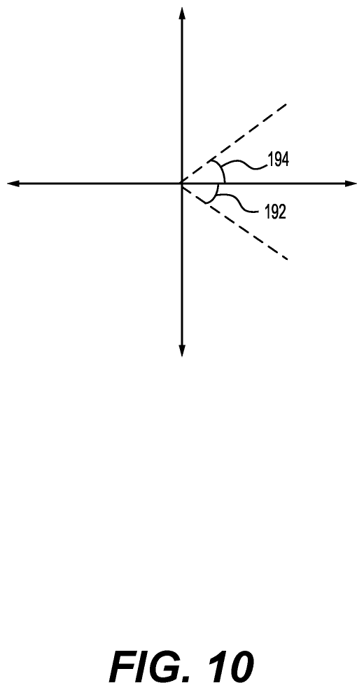

FIG. 10 illustrates a schematic diagram of an example taper angle of the comb attachment 100. In some examples, the first taper angle value 192 may be in a range of about −30° to 0° and the second taper angle value 194 may be in a range of about 0° to +30°. As used herein, a taper angle may be defined as an angle that is formed between a horizontal line 186 (e.g., a line that is parallel with a width direction of the blade section of the hair clipper 200) and a distal edge 188 of the comb blade guide. By a relative movement of the first and second guiding sliders 140, 150, the taper angle of the comb attachment 100 can be adjusted to have any angle between −30° and +30°.

Aspects of the present disclosure may enable the comb attachment 100 to adjust the taper direction, the taper angle, and the length simultaneously. For example, by a relative movement of the first and second guiding sliders 140, 150 (e.g., pushing one guiding slider while pulling another guiding slider), a taper direction and a taper angle may be formed, and in a given tapering direction/angle, by pushing or pulling the guiding sliders 140, 150 together in the same direction (and in the same amount), the length of the comb attachment 100 can be adjusted.

In this way, aspects of the present disclosure may provide a single comb attachment that can provide multiple degrees (e.g., at least four) of freedom to adjust a length, a taper direction (left or right), and a taper angle (multiple angles) at the same time. In particular, the comb attachment according to the present disclosure can adjust the starting and ending taper length (e.g., length of the left side and right side). In order to provide the various length, taper direction, and taper angle options that can be provided by the comb attachment according to the present disclosure, at least dozens of or even hundreds of rigid/fixed combs may be needed, which may not be practical and economical. Therefore, the comb attachment according to the present disclosure may be user-friendly and eco-friendly.

In some examples, the comb attachment 100 may further include one or more hair clipper size adjusters 172, 174. The one or more hair clipper size adjusters 172, 174 may be provided to use the comb attachment 100 with multiple hair clippers in various sizes. For example, when the size of a hair clipper is smaller than the internal hollow space 125 of the base case 120, the one or more hair clipper size adjusters 172, 174 can be inserted between the hair clipper 200 and the base case 120.

In some cases, the base case 120 may have one or more internal recesses 126, 127 configured to accept the one or more hair clipper size adjusters 172, 174. For example, the comb attachment 100 may include a first hair clipper size adjuster 172 and a second hair clipper size adjuster 174. The base case 120 may include a first internal recess 126 configured to accept the first hair clipper size adjuster 172, and a second internal recess 127 configured to accept the second hair clipper size adjuster 174.

In some examples, the first internal recess 126 may be formed on an internal surface of the second wall 122, and the second internal recess 127 may be formed on an internal surface of the fourth wall 124. In other examples, the first internal recess 126 and the second internal recess 127 can be formed on any other walls. In some other examples, any other number of hair clipper size adjusters and internal recesses (e.g., 1, 2, 3, 4, 5, 6, . . . ) can be formed.

In some examples, the one or more hair clipper size adjusters 172, 174 may have various thicknesses. In some examples, the hair clipper size adjusters 172, 174 may have a thickness in a range of 0.5 mm to 5 mm. In other examples, the hair clipper size adjusters 172, 174 may have any other suitable thickness.

In some examples, the comb attachment 100 may further include a band 175. The band 175 may be made with an elastic material (e.g., rubber) and exert a shrinking force, for example, when stretched, to regain its original shape. When the one or more hair clipper size adjusters 172, 174 are inserted between the hair clipper 200 and the base case 120, the one or more hair clipper size adjusters 172, 174 can be more firmly tied to the hair clipper 200 by using the band 175. In some examples, the one or more hair clipper size adjusters 172, 174 may include one or more hooks 176, 178 to keep the band 175 on the one or more hair clipper size adjusters 172, 174 so that the band 175 can firmly tie the one or more hair clipper size adjusters 172, 174 to the hair clipper 200.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B,” “one or more of A and B,” and “A and/or B” are each intended to mean “A alone, B alone, or A and B together.” A similar interpretation is also intended for lists including three or more items. For example, the phrases “at least one of A, B, and C”; “one or more of A, B, and C”; and “A, B, and/or C” are each intended to mean “A alone, B alone, C alone, A and B together, A and C together, B and C together, or A and B and C together.” Use of the term “based on” above and in the claims is intended to mean “based at least in part on,” such that an unrecited feature or element is also permissible.

All ranges described are intended to include all numbers, whole or fractions, contained within the said range. As used herein, “about,” “approximately,” and “substantially” are understood to refer to numbers in a range of numerals, for example, the range of −10% to +10% of the referenced number, preferably −5% to +5% of the referenced number, more preferably −1% to +1% of the referenced number, or most preferably −0.1% to +0.1% of the referenced number. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

As used herein, the singular forms “a”, “an,” and “the” are intended to include the plural forms as well, unless otherwise indicated. It will be further understood that the terms “comprises” and/or “comprising,” when used in this specification, specify the presence of stated features, integers, steps, operations, elements, and/or components, but they do not preclude the presence or addition of one or more other features, integers, steps, operations, elements, components, and/or groups thereof.

Reference throughout the specification to “various examples,” “some examples,” “one example,” “an example,” “another example,” or the like, means that a particular feature, structure, or characteristic described in connection with the example is included in at least one example. Thus, appearances of the phrases “various examples,” “some examples,” “one example,” “an example,” “another example,” or the like, in places throughout the specification are not necessarily all referring to the same example. Furthermore, the particular features, structures, or characteristics may be combined in any suitable manner in one or more embodiments. Thus, the particular features, structures, or characteristics illustrated or described in connection with one embodiment/example may be combined, in whole or in part, with the features, structures, or characteristics of one or more other embodiments/examples without limitation. Such modifications and variations are intended to be included within the scope of the present invention.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above.

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims. Moreover, consistent with current U.S. law, it should be appreciated that 35 U.S.C. § 112(f) or pre-AIA 35 U.S.C. § 112, paragraph 6 is not intended to be invoked unless the terms “means” or “step” are explicitly recited in the claims. Accordingly, the claims are not meant to be limited to the corresponding structure, material, or actions described in the specification or equivalents thereof

The invention is claimed as follows:

1. A comb attachment for a hair clipper, the comb attachment comprising:
a comb blade guide having a plurality of fins, wherein each of the plurality of fins comprises:
a first end portion;
a middle portion, wherein the middle portion is bent; and
a second end portion opposite the first end portion;
a base case configured to be removably attached to a hair clipper;
a first guiding slider; and
a second guiding slider,
wherein the base case comprises:
a first wall;
a second wall;
a third wall opposite the first wall; and
a fourth wall opposite the second wall, wherein the first, second, third, and fourth walls together form an internal hollow space configured to accept the hair clipper,
wherein the first end portion of each of the plurality of fins is movably attached to an outer surface of the first wall, and the second end portion of each of the plurality of fins is movably attached to an outer surface of the third wall,
wherein the first guiding slider is movably attached to an outer surface of the second wall, and the second guiding slider is movably attached to an outer surface of the fourth wall,
wherein the first and second guiding sliders are configured to adjust a taper angle of the comb blade guide and a length of the comb attachment.

2. The comb attachment of claim 1, wherein the first wall of the base case comprises a first group of sliding recesses formed on the outer surface thereof, wherein each of the first group of sliding recesses is configured to accept the first end portion of a corresponding fin, wherein the first end portion of the corresponding fin is configured to slide back and forth on a corresponding sliding recess on the first wall.

3. The comb attachment of claim 2, wherein the third wall of the base case comprises a second group of sliding recesses formed on the outer surface thereof, wherein each of the second group of sliding recesses is configured to accept the second end portion of a corresponding fin, wherein the second end portion of the corresponding fin is configured to slide back and forth on a corresponding sliding recess on the third wall.

4. The comb attachment of claim 1, further comprising a first connector coupled to the first guiding slider and the second guiding slider, wherein the first end portion of each of the plurality of fins includes a recess configured to accept the first connector.

5. The comb attachment of claim 4, further comprising a second connector coupled to the first guiding slider and the second guiding slider, wherein the second end portion of each of the plurality of fins includes a recess configured to accept the second connector.

6. The comb attachment of claim 1, wherein the second wall of the base case comprises a first protrusion, and the first guiding slider comprises a first groove configured to accept the first protrusion, wherein the first guiding slider is configured to slide back and forth along the first protrusion.

7. The comb attachment of claim 6, wherein the first protrusion comprises one or more side surfaces facing the first guiding slider, wherein the one or more side surfaces of the first protrusion comprise a plurality of first sections defined by a plurality of first sub-protrusions, wherein the first guiding slider is secured within one of the plurality of first sections.

8. The comb attachment of claim 6, wherein the fourth wall of the base case comprises a second protrusion, and the second guiding slider comprises a second groove configured to accept the second protrusion, wherein the second guiding slider is configured to slide back and forth along the second protrusion.

9. The comb attachment of claim 8, wherein the second protrusion comprises one or more side surfaces facing the second guiding slider, wherein the one or more side surfaces of the second protrusion comprise a plurality of second sections defined by a plurality of second sub-protrusions, wherein the second guiding slider is secured within one of the plurality of second sections.

10. The comb attachment of claim 1, wherein the first end portion and the second end portion of the fins are substantially in parallel with each other.

11. The comb attachment of claim 1, wherein the taper angle of the comb blade guide is adjusted by a relative movement of the first guiding slider and the second guiding slider.

12. The comb attachment of claim 1, wherein the length of the comb attachment is increased by pushing the comb blade guide in a distal direction using the first guiding slider and the second guiding slider.

13. The comb attachment of claim 12, wherein the length of the comb attachment is decreased by pulling the comb blade guide in a proximal direction using the first guiding slider and the second guiding slider.

14. The comb attachment of claim 1, wherein the taper angle is in a range of about −30° to +30°.

15. A hair-clipping assembly comprising:
a hair clipper; and
a comb attachment comprising:
a comb blade guide having a plurality of fins, wherein each of the plurality of fins comprises:
a first end portion;
a middle portion, wherein the middle portion is bent; and
a second end portion opposite the first end portion;
a base case configured to be removably attached to the hair clipper;
a first guiding slider; and
a second guiding slider,
wherein the base case comprises:
a first wall;
a second wall;
a third wall opposite the first wall; and
a fourth wall opposite the second wall, wherein the first, second, third, and fourth walls together form an internal hollow space configured to accept the hair clipper,
wherein the first end portion of each of the plurality of fins is movably attached to an outer surface of the first wall, and the second end portion of each of the plurality of fins is movably attached to an outer surface of the third wall,
wherein the first guiding slider is movably attached to an outer surface of the second wall, and the second guiding slider is movably attached to an outer surface of the fourth wall,
wherein the first and second guiding sliders are configured to adjust a taper angle of the comb blade guide and a length of the comb attachment.

16. The hair-clipping assembly of claim 15, wherein the first wall of the base case comprises a first group of sliding recesses formed on the outer surface thereof, wherein each of the first group of sliding recesses is configured to accept the first end portion of a corresponding fin, wherein the first end portion of the corresponding fin is configured to slide back and forth on a corresponding sliding recess on the first wall, and
wherein the third wall of the base case comprises a second group of sliding recesses formed on the outer surface thereof, wherein each of the second group of sliding recesses is configured to accept the second end portion of a corresponding fin, wherein the second end portion of the corresponding fin is configured to slide back and forth on a corresponding sliding recess on the third wall.

17. The hair-clipping assembly of claim 15, further comprising:
a first connector coupled to the first guiding slider and the second guiding slider, wherein the first end portion of each of the plurality of fins includes a recess configured to accept the first connector; and
a second connector coupled to the first guiding slider and the second guiding slider, wherein the second end portion of each of the plurality of fins includes a recess configured to accept the second connector.

18. The hair-clipping assembly of claim 15, wherein the second wall of the base case comprises a first protrusion, and the first guiding slider comprises a first groove configured to accept the first protrusion, wherein the first guiding slider is configured to slide back and forth along the first protrusion, and
wherein the fourth wall of the base case comprises a second protrusion, and the second guiding slider comprises a second groove configured to accept the second protrusion, wherein the second guiding slider is configured to slide back and forth along the second protrusion.

19. The hair-clipping assembly of claim 18, wherein the first protrusion comprises one or more side surfaces facing the first guiding slider, wherein the one or more side surfaces of the first protrusion comprise a plurality of first sections defined by a plurality of first sub-protrusions, wherein the first guiding slider is secured within one of the plurality of first sections, and
wherein the second protrusion comprises one or more side surfaces facing the second guiding slider, wherein the one or more side surfaces of the second protrusion comprise a plurality of second sections defined by a plurality of second sub-protrusions, wherein the second guiding slider is secured within one of the plurality of second sections.

20. The hair-clipping assembly of claim 15, wherein the first end portion and the second end portion of the fins are substantially in parallel with each other.
